(19) United States
(12) Patent Application Publication
(10) Pub. No.: US 2007/0118653 A1
(43) Pub. Date: May 24, 2007

(54) System, method, and computer program product for throttling client traffic

(75) Inventor: Nitinkumar S. Bindal, Grapevine, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc.

(21) Appl. No.: 11/285,431

(22) Filed: Nov. 22, 2005

(51) Int. Cl. G06F 15/173; G06F 15/16

(52) U.S. Cl. 709/226; 709/235

(57) ABSTRACT

A system for throttling data traffic on a network to a client includes an application node and a throttle manager. The application node receives requests from the client via the network. The throttle manager is in communication with the application node. The throttle manager is configured to track a parameter that is based on a number of active requests associated with a user identifier associated with the client. The throttle manager is configured to determine whether to restrict responses to the requests responsive to a relationship of the parameter to a threshold.

### FIELD OF THE INVENTION

The present invention relates generally to systems, methods, and computer program products for managing data flow within a software system, and more particularly, to systems, methods, and computer program products for throttling client traffic.

### BACKGROUND OF THE INVENTION

In a software system, such as for example a web system of a typical service providing website, large numbers of users or customers may direct traffic to the software system. Such traffic is initiated by the user from a client station which may be either fixed or mobile and is in communication with the software system, for example, via a fixed network in communication with the internet. A user could also be another computer program sending requests to the software system. Accordingly, a typical software system includes software applications deployed on multiple nodes or hardware boxes in order to serve the volume of traffic directed to the software system. Traffic from specific users may be directed to any one of the multiple nodes. Traffic direction is commonly performed by a load balancing product known in the art.

Under certain circumstances, there may be a large number of users, who may each direct extensive amounts of traffic to the software system. As a volume of user traffic increases problems can result. Due to limited network bandwidth, communications over the network may be slow during times of peak activity. Additionally, servers or nodes hosting the software applications may not be able to handle the increased activity, resulting in delayed responses or error responses to requests made by users. During such periods of high activity, it may be necessary for the software system to employ mechanisms by which traffic coming from a particular user may be limited.

For example, in the travel industry, service providers allow users to book hotels, airline flights, vacations, etc. online using the processing power of servers that host software applications configured for such purposes. In such a context, there may be certain instances where the servers are required to process a large volume of requests in a relatively short period of time, thereby creating a slowdown of the provision of the service.

Current solutions to the above problem include network based bandwidth control measures. As such, the network which is situated between users and the software system controls a bandwidth that is allotted to any particular user. Bandwidth is limited in terms of a number of kilobytes of data the network allows the particular user to send or receive at any given time. Bandwidth control at the network level is not always desirable or useful in preventing the network slowdowns described above. In this regard, a disadvantage of bandwidth control at the network level is that user identification is done via IP address or address range. It is difficult to manage bandwidth control at the network level via IP address identification since the software system identifies users by other means, for example, username and password. Another disadvantage of bandwidth control at the network level is that it is often difficult to determine an appropriate bandwidth for a user. Furthermore, it may be possible for a user to make a large number of requests that slow down the software system while remaining below the network's bandwidth limits. Moreover, given the mobility of users and user equipment, it is often impractical to identify users by an IP address in order to authenticate and authorize user transactions.

There is, therefore, a need for a system, method and computer program product for an improved mechanism to throttle user traffic.

### BRIEF SUMMARY OF THE INVENTION

A system, method and computer program product are therefore provided according to one embodiment that throttle or limit user traffic based on a number of requests opened against a particular software application or a number of requests currently being processed for a given user. Additionally, a system, method and computer program product are provided according to another embodiment that throttle user traffic based on the rate at which a particular user is sending requests to a particular software application. Furthermore, limits to user traffic are managed by tracking requests from a particular user by using that user's security identification in the software system. Accordingly, traffic bound for a software application may be controlled to reduce the occurrence of slow application operation due to a high volume of activity associated with particular users as identified by the user identifier of the user instead of by the IP address of the user.

In an exemplary embodiment, a method of throttling data traffic to a client is provided. The method includes receiving notification of a client request associated with a user identifier, incrementing a recorded number of active requests for the user identifier, determining, responsive to the incremented number of active requests, whether a parameter based on the incremented recorded number of active requests is above a threshold, and determining whether to restrict data traffic to the client responsive to a relationship of the parameter to the threshold.

In another exemplary embodiment, a computer program product for throttling data traffic to a client is provided. The computer program product includes at least one computer-readable storage medium having computer-readable program code portions stored therein. The computer-readable program code portions include first to fourth portions. The first portion is for receiving notification of a client request associated with a user identifier. The second portion is for incrementing a recorded number of active requests for the user identifier. The third portion is for determining, responsive to the incremented number of active requests, whether a parameter based on the incremented recorded number of active requests is above a threshold. The fourth portion is for determining whether to restrict data traffic to the client responsive to a relationship of the parameter to the threshold.

In another exemplary embodiment, a method of throttling data traffic to a client is provided. The method includes receiving notification of a client request associated with a feature identifier, incrementing a recorded number of active requests for the feature identifier, determining, responsive to the incremented number of active requests, whether a parameter based on the incremented recorded number of active requests is above a threshold, and determining whether to restrict data traffic to the client responsive to a relationship of the parameter to the threshold.

In another exemplary embodiment, a computer program product for throttling data traffic to a client is provided. The computer program product includes at least one computer-readable storage medium having computer-readable program code portions stored therein. The computer-readable program code portions include first to fourth portions. The first portion is for receiving notification of a client request associated with a feature identifier. The second portion is for incrementing a recorded number of active requests for the feature identifier. The third portion is for determining, responsive to the incremented number of active requests, whether a parameter based on the incremented recorded number of active requests is above a threshold. The fourth portion is for determining whether to restrict data traffic to the client responsive to a relationship of the parameter to the threshold.

In another exemplary embodiment, a system for throttling data traffic to a client is provided. The system includes an application node and a throttle manager. The application node receives requests from the client via the network. The throttle manager is in communication with the application node. The throttle manager is configured to track a parameter that is based on a number of active requests associated with a user identifier associated with the client. The throttle manager is configured to determine whether to restrict responses to the requests responsive to a relationship of the parameter to a threshold.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system for throttling user traffic, according to an exemplary embodiment of the present invention;

FIG. 2 is a control flow diagram illustrating a method for throttling user traffic, according to an exemplary embodiment of the present invention;

FIG. 3 is another control flow diagram illustrating a method for throttling user traffic, according to an exemplary embodiment of the present invention;

FIG. 4 is yet another control flow diagram illustrating a method for throttling user traffic, according to an exemplary embodiment of the present invention; and

FIG. 5 is a flowchart of the operation of improving the throttling of user traffic, according to one embodiment of the present invention.

### DETAILED DESCRIPTION OF THE INVENTION

The present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

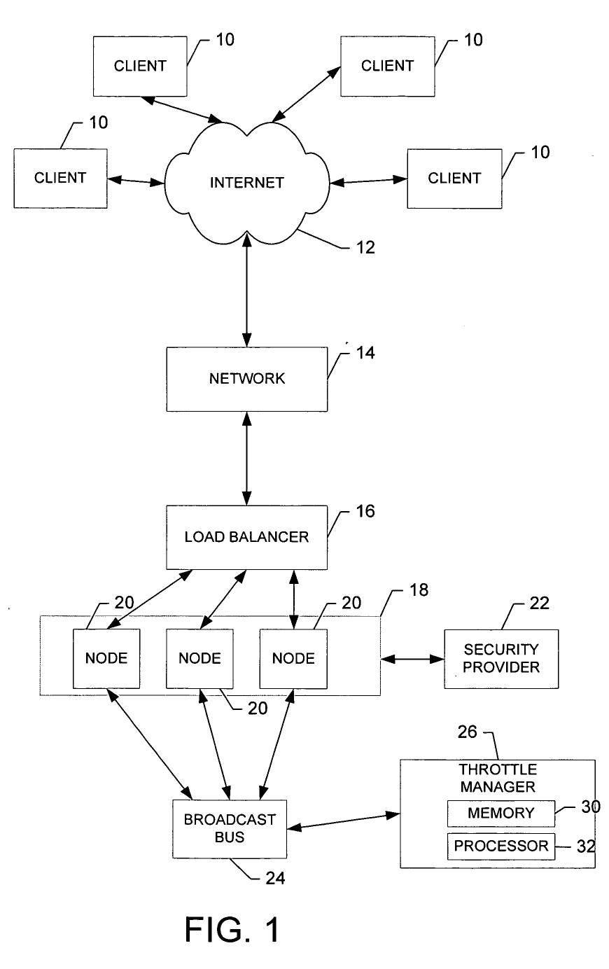

FIG. 1 is a schematic block diagram of a system for throttling user traffic, according to one embodiment of the present invention. A plurality of users or customers may access the system via client devices, referred to hereinafter as clients 10. A client 10 as described herein may be any device capable of accessing public networks, proprietary networks, the internet 12, etc. For example, the client 10 may be a mobile phone, personal digital assistant (PDA), desktop computer, laptop computer, another software system running on a computer, etc. A user may desire to access an application node cluster 18 which enables the user to, for example, shop for and purchase items or access particular features. In order to route packets of data to and from a particular user, protocols have been established which identify the client 10 of the particular user and route packets to and from the internet protocol (IP) address of the corresponding client 10. Given the ubiquitous nature of clients 10, the mobility of clients 10 and the mobility of users among different clients 10, it is often necessary for networks to identify users by an identity other than an IP address in order to authenticate and authorize user transactions. Thus, in order to access the application 18, the user is often required to provide a user identifier. The user identifier may be called an application credential, user id, application client identifier, security identifier, etc. and often includes, for example, a username and password that is unique to the user and independent of the device or client and therefore independent of the location of the device or client within the network. Thus, the user identifier is not associated with any particular device, machine, access port, etc., but rather associated with a particular user.

In an exemplary embodiment of the present invention, as shown in FIG. 1, clients 10 communicate client requests initiated by the user to the internet 12, which are then communicated to the network 14. Communication between clients 10, the internet 12, and a network 14 are well known and are therefore not described in detail in this disclosure. A client request may include a request to access data stored at an address at application node cluster 18 for which the network 14 controls access. Alternatively, the application node cluster 18 may interface with application to fulfill the request. The application node cluster 18 includes a plurality of nodes or application nodes 20. Each of the application nodes 20 may be, for example, a service gateway device, a server, etc., which is adapted to providing a response to an authorized and authenticated client request. Each client request identifies the user identifier of the requesting user at the corresponding client 10. When the application node 20 receives the client request, the application node 20 uses the user identifier to authorize and authenticate the user. If the client request is authorized and authenticated, the application node 20 provides a response to the client request, which is routed through the network 14 to the client 10.

Authentication and authorization are typically done by a security provider 22 in communication with each of the application nodes 20 of the application node cluster 18. It should be noted that although FIG. 1 shows the security provider 22 as an external device, the security provider 22 may be internal to the application node cluster 18. Alternatively, the security provider 22 may be embodied as a security device disposed at each of the application nodes 20.

Responding to each client request consumes processing power within the application nodes 20. Accordingly, as a number of active or pending client requests increases, a corresponding increased percentage of processing capability of each of the application nodes 20 is consumed. When the processing capability is fully consumed, response times of the application nodes 20 slow down. There is a potential for very high volumes of client requests, which subsequently slow down response times of the application nodes 20. Such a slow down is particularly likely if a particular application node 20 is overloaded with a disproportionate share of client requests. Thus, many networks employ a load balancer 16. The load balancer 16 distributes client requests among the application nodes 20 in an effort to provide a relatively even distribution of client requests among the application nodes 20, thereby decreasing the effects of high volumes of client requests.

To further alleviate slow down in response times due to high volumes of client requests, a throttle manager 26 is employed. The throttle manager 26 is adapted to throttling client requests associated with a particular identified subject. In an exemplary embodiment, the particular identified subject is a user identifier that may be associated with a particular user. Specifically, the throttle manager 26 tracks either a number of active requests associated with the user identifier or a rate of requests from the user identifier. When a threshold of either the rate of requests or the number of active requests is reached, the throttle manager 26 takes action to throttle or limit the amount of processing power that the requests associated with a given user identifier are allowed to consume. The throttle manager 26 may be disposed apart from the node cluster 18 and in communication with each of the application nodes 20 via a broadcast bus 24 as shown in FIG. 1. Alternatively, the throttle manager 26 may be disposed, for example, internal to the node cluster 18. Communication between the application nodes 20 and the throttle manager 26 may be conducted via any known protocol such as, for example, transmission control protocol (TCP) IP. It should be noted that the rate of requests may be calculated by any known means of rate calculation. However, in an exemplary embodiment, the rate of requests is determined by calculating a number of active requests received in a given time.

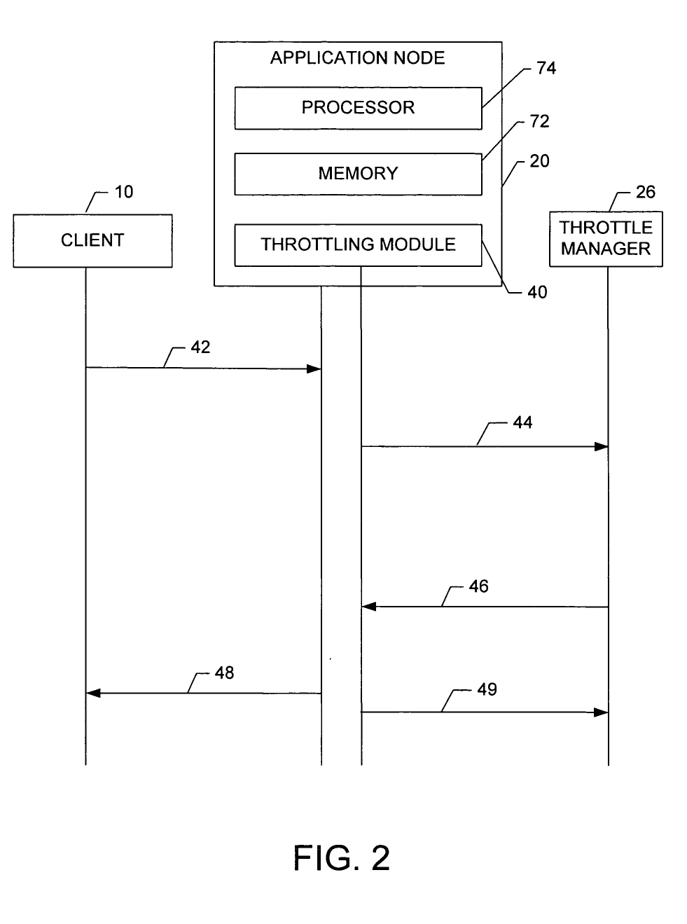

FIGS. 2-4 are control flow diagrams illustrating a method for throttling user traffic, according to an exemplary embodiment of the present invention. Operation of the system for throttling user traffic will now be described in reference to FIGS. 1-4. It should be noted that although the description below refers to a single client request received at a single application node 20, the throttle manager 26 performs the procedure described below for each client request received at each of the application nodes 20.

FIG. 2 is a control flow diagram illustrating a method for throttling user traffic in which throttling is required. A client request 42 is sent from a client 10 to an application node 20 via communication channels described above. In response to receipt of the client request 42, a throttling module 40 of the application node 20 sends a first message 44 to the throttle manager 26 to inform the throttle manager 26 of the request. It should be noted that the throttling module 40 is simply a portion of the application node 20 that interfaces with the throttling manager 26. As such, the throttling module 40 is not necessarily a separate element from the application node 20. In fact, the throttling module 40 may be embodied in software instructions stored in a memory 72 of the application node 20 and executed by a processor 74 of the application node 20.

The first message 44 includes the user identifier and an indicator indicating that the client request 42 has been received. The throttle manager 26 tracks, for each user identifier, a number of active requests and/or a number of requests received over a given unit of time. In other words, the throttle manager 26 may track a number of active requests, a rate of requests, or both the number of active requests and the rate of requests. It should be noted that such tracking may be done in memory, or any other suitable means. Tracking based on the user identifier ensures that throttling of client requests is applied based on the user identifier and, therefore, regardless of IP address.

In response to receipt of the first message 44, the throttle manager 26 increments the number of active requests and/or updates the rate of requests. An updated number of active requests and/or rate of requests is then compared to a corresponding number threshold or rate threshold. The number and rate thresholds corresponding to the number of active requests and the rate of requests are representative of a maximum number of allowable active requests for the user identifier and a maximum allowable rate of requests for the user identifier, respectively. In response to either of the updated number of active requests and/or rate of requests being above the corresponding number and/or rate thresholds, the throttle manager 26 sends a throttle message 46 to the throttling module 40 of each of the application nodes 20 via the broadcast bus 24. In response to receipt of the throttle message 46, each of the application nodes 20 places the user identifier on a throttle list, if the user identifier is not already on the list. The throttle list represents a mechanism by which client requests from users associated with the user identifier are designated for throttling. In response to receipt of the client request 42 while the user identifier is on the throttle list and above the corresponding number and/or rate thresholds, the application node 20 is preempted from sending a response, and instead sends an error message 48 to the client 10. The error message 48 may simply indicate that an error has occurred and the client request 42 cannot be processed. Alternatively, the error message 48 may provide further information to the client 10. For example, the error message 48 may explain why the client request 42 was not processed. Furthermore, the error message 48 may include an optional feature of extending an offer for the user associated with the user identifier to obtain higher thresholds, for example, by purchasing the higher thresholds. After the error message 48 is sent to client 10, the throttling module 40 sends a notifying message 49 to the throttle manager 26. The notifying message 49 includes the user identifier and an indicator, indicating that a response has been sent. In response to receipt of the notifying message 49, the throttle manager 26 decrements the number of active request for the user identifier. The notifying message 49 may alternatively be sent just before the error message 28 is sent to the client 10.

In an exemplary embodiment, instead of simply sending the error message 48 to the client 10 in response to the user identifier having a parameter above threshold, an error may only be produced for that portion of client traffic that is above threshold. For example, a request reject number may be calculated at the throttle manager 26 by dividing the current number of active requests by the difference between the current number of active requests and the maximum allowable number of active requests (threshold) for the user identifier. The request reject number may then be sent to each of the application nodes 20, which subsequently keep a count for each user identifier on the throttle list in the throttling module 40 of the application node 20. The count is incremented with each new request associated with the user identifier, and the count is compared to the request reject number. If a modulus of the request reject number and the count is zero, then the throttling module 40 returns an error message. If the modulus is not zero, then the request is processed normally and a response may be returned to the client 10.

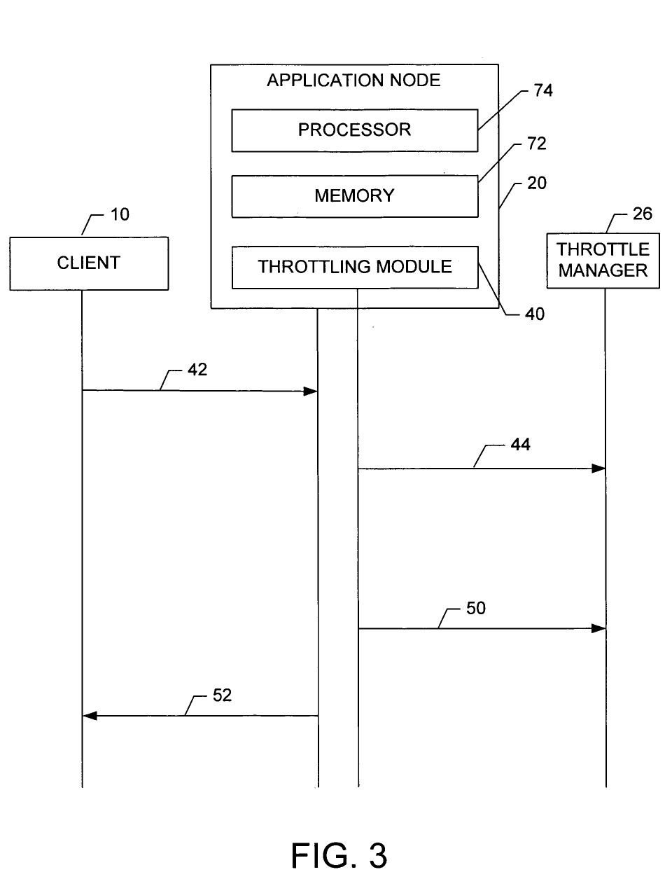

FIG. 3 is a control flow diagram illustrating a method for throttling user traffic in which throttling is not required. The client request 42 is sent from the client 10 to the application node 20 as described above. In response to receipt of the client request 42, the throttling module 40 sends the first message 44 to the throttle manager 26. In response to receipt of the first message 44, the throttle manager 26 increments the number of active requests and/or updates the rate of requests. The updated number of active requests and/or rate of requests is then compared to the corresponding number and/or rate thresholds. In response to both of the updated number of active requests and/or rate of requests being below the corresponding number and rate thresholds, the throttle manager 26 determines whether the user identifier is on the throttle list since the user identifier should be removed therefrom as described below if the user identifier is, in fact, on the throttle list. In response to the user identifier not being on the throttle list, the application node 20 is not preempted from sending a response to the client 10 and the throttle manager 26 notifies the application node 20. Accordingly, the application node 20 sends a second message 50 to the throttle manager 26 to indicate that the request is no longer active since the request is being fulfilled. In response to receipt of the second message 50, the throttle manager 26 decrements the number of active requests. After the second message 50 is sent to the throttle manager 26, the application node 20 sends a client response 52 to the client 10. It should be noted that the second message 50 and the client response 52 may alternatively be sent in any order or even simultaneously.

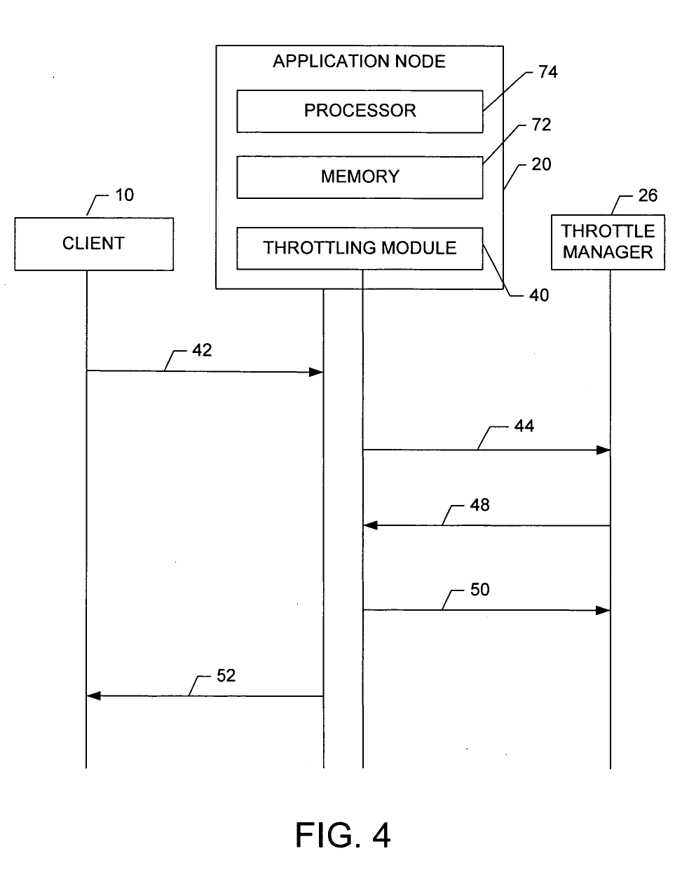

FIG. 4 is a control flow diagram illustrating a method for throttling user traffic in which throttling is no longer required. The client request 42 and the first message 44 are transmitted as described above. In response to receipt of the first message 44, the throttle manager 26 increments the number of active requests and/or updates the rate of requests. The updated number of active requests and/or rate of requests is then compared to the corresponding number and/or rate thresholds. In response to both of the updated number of active requests and/or rate of requests being below the corresponding number and rate thresholds, the throttle manager 26 determines whether the user identifier is on the throttle list. In response to the user identifier being on the throttle list, the throttle manager 26 sends a message, which may be referred to as a clearance message 54, to the throttling module 40 via the broadcast bus 24, to indicate that the user identifier may be cleared or removed from the throttle list. The application node 20 removes the user identifier from the throttle list responsive to receipt of the clearance message 54 and thus the application node 20 is not preempted from sending a response to the client 10. Accordingly, the application node 20 sends the second message 50 to the throttle manager 26 to indicate that the request is no longer active since the request is being fulfilled. In response to receipt of the second message 50, the throttle manager 26 decrements the number of active requests. After the second message 50 is sent to the throttle manager 26, the application node 20 sends the client response 52 to the client 10.

In an exemplary embodiment, a threshold for issuance of the throttle message 46 and a threshold for issuance of a clearance message 54 may be different values. For example, the threshold for the issuance of the throttle message 46 may be greater than the threshold for issuance of the clearance message 54 such as exemplified by an embodiment in which the throttle message 46 is issued when the active number of requests is 250 and the clearance message 54 is issued when the active number of requests is 225. By setting the threshold for issuance of a clearance message lower than the threshold for issuance of a throttle message, repeated toggling of the user identifier onto and off of the throttle list may be avoided. It should also be noted that although embodiments of the invention are described above as limiting access of a particular user, the throttle manager 26 may alternatively be configured to determine a number of requests made to a particular application resource of the application node cluster 18 and/or a rate of requests made to that particular application resource. In such a case, the system, and method described above would operate the same except that a name identifying the particular application resource, or application resource identifier, would be used instead of the user identifier. Thus, for example, in response to a client request that results in access of the application resource, the number of active requests associated with application resource identifier would increment and the throttle manager 26 would determine if the application resource had received a number or rate of requests above threshold and, if necessary, throttle access for all users to the application resource until the number or rate of requests is below threshold.

The application resource identifier may be used to designate any system or computing resource that the application node 20 uses in order to fulfill a request. Examples of an application resource include, for example a specific functionality or service available on application to the user, or a source of data or website which the application node 20 must access in order to fulfill a particular request. For example, on a travel web-site, if access to a travel coupon feature needs to be throttled, an application resource identifier “TravelCoupon” can be designated to this feature. In such a case, it may be advantageous to employ the method and system described above by replacing the user identifier with the application resource identifier and thereby throttling access to the feature based on a number or rate of requests to the feature regardless of both IP address and user identifier. As another example, if the application node 20 needs to access an external server or data-source to fulfill a user request and, due to contractual or other constraints a total number of active request to the external server from all of the nodes within the application node cluster 18 is limited, then an application resource identifier can be designated for the external server. In such a case, the method and system described above can be employed by replacing user identifier with the application resource identifier designated to the external server and thereby throttling access to the feature based on number or rate of requests to the external server regardless of both IP address and user identifier.

In an exemplary embodiment involving the travel industry, the client request 42 may be a request for rate or availability information related to a hotel room, a rental car, an airline ticket, etc. Accordingly, the client response 52 would be the corresponding rate or availability information.

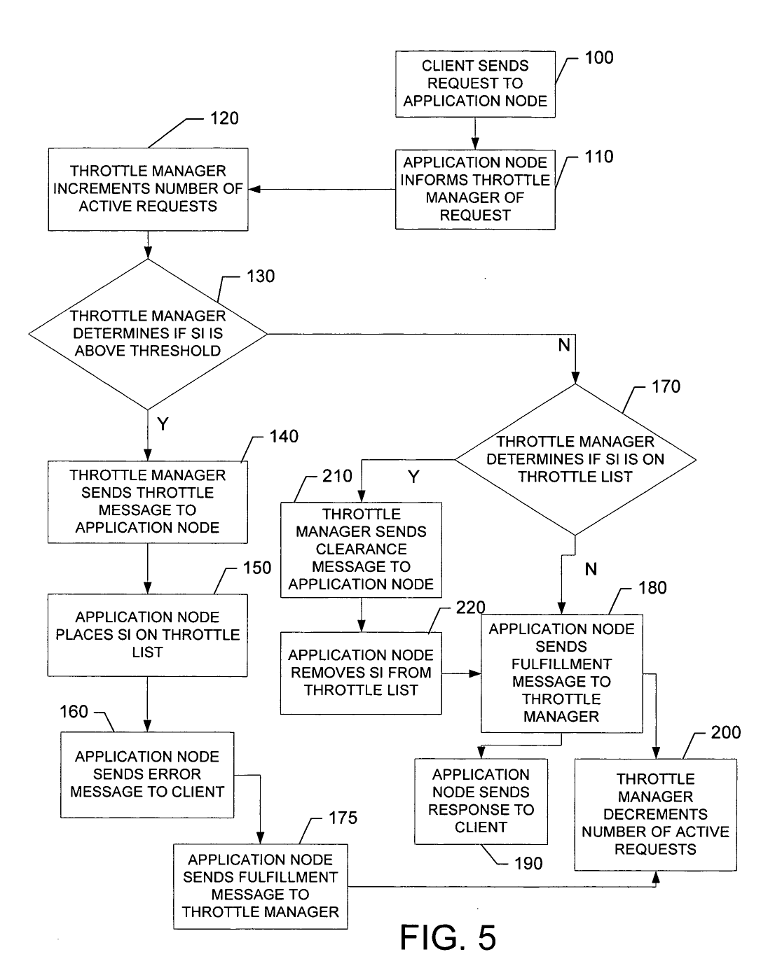

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by memories 30 and 72 of both the throttle manager 26 and the application node 20, respectively. The computer program instructions may then be executed by built-in processors 32 and 74 of both the throttle manager 26 and the application node 20, respectively. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for throttling client traffic includes a client having a user identifier (UI) sending a request to an application node at operation 100. The application node informs a throttle manager of the request at operation 110. Such informing by the application node may be made by a short message simply indicating the existence of a request and the UI of the requester associated with the client. At operation 120, the throttle manager increments a number of active requests for the UI. The throttle manager then determines if the UI is above a threshold number of active requests at operation 130. If the UI is above the threshold number of active requests, the throttle manager sends a throttle message to all application nodes at operation 140. Responsive to the throttle message, the application nodes each place the UI on a throttle list indicating UIs whose access must be throttled at operation 150. At operation 160, the application node responds to the request with an error message and the request is not processed further. At operation 165, a fulfillment message is sent to the throttle manager, thereby causing the throttle manager to decrement a number of active requests associated with the UI at operation 200. It should be noted that in an exemplary embodiment, the request may receive further processing such as, for example, placement of the request on a queue to be processed when the UI is below the threshold number of active requests. If the UI is not above the threshold number of active requests, the throttle manager determines if the UI is on the throttle list at operation 170. If the UI is not on the throttle list, the application node is allowed to send a response to the client at operation 190. Prior to sending the response to the client, the application node informs the throttle manager that the response will be sent to the client via a fulfillment message at operation 180. It should be noted that the order of the operations of informing the throttle manager and sending a response is not important. Responsive to the fulfillment message, the throttle manager decrements the number of active requests by one at operation 200. If the throttle manager determines that the UI is on the throttle list at operation 170, the throttle manager sends a clearance message to the application nodes at operation 210 since the throttle manager has determined that the UI is below the threshold number of active requests. Responsive to the clearance message, the application node removes the UI from the throttle list at operation 220. Accordingly, the application node may inform the throttle manager that the response will be sent to the client and send the response at operations 180 and 190, respectively.

Although the operations described above refer only to an embodiment in which a threshold determination is based on the number of active requests, it should be noted that the present invention is not exclusively bound to such a determination. For example, as described above, the throttle manager may alternatively or additionally determine if a rate of requests from the client is above a threshold number.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of throttling data traffic to a client comprising:
receiving notification of a client request associated with a user identifier;
incrementing a recorded number of active requests for the user identifier;
determining, responsive to the incremented number of active requests, whether a parameter based on the incremented recorded number of active requests is above a threshold; and
determining whether to restrict data traffic to the client responsive to a relationship of the parameter to the threshold.

2. The method of claim 1, further comprising sending a message to direct that the user identifier be added to a list of user identifiers to be throttled responsive to the parameter being above the threshold.

3. The method of claim 1, further comprising determining whether the user identifier is on a list of user identifiers to be throttled in response to the parameter being below the threshold.

4. The method of claim 3, further comprising sending a message to remove the user identifier from the list in response to the user identifier being on the list.

5. The method of claim 3, further comprising receiving an indication that a response is being sent to the client in response to the user identifier not being on the list.

6. The method of claim 5, further comprising decrementing the recorded number of active requests in response to receipt of the indication.

7. The method of claim 1, wherein the parameter is at least one of a number of active requests and a number of active requests per a given unit of time.

8. The method of claim 8, further comprising decrementing the recorded number of active requests in response to receipt of a message indicating that data traffic to the client has been restricted.

9. A computer program product for throttling data traffic to a client, the computer program product comprising at least one computer-readable storage medium having computer-readable program code portions stored therein, the computer-readable program code portions comprising:
a first executable portion capable of receiving notification of a client request from a user identifier;
a second executable portion capable of incrementing a recorded number of active requests for the user identifier;
a third executable portion capable of determining, responsive to the incremented number of active requests, whether a parameter based on the incremented recorded number of active requests is above a threshold; and
a fourth executable portion capable of determining whether to restrict data traffic to the client responsive to a relationship of the parameter to the threshold.

10. The computer program product of claim 9, further comprising a fifth executable portion capable of sending a message to direct the user identifier to be added to a list of user identifiers to be throttled responsive to the parameter being above the threshold.

11. The computer program product of claim 9, further comprising a fifth executable portion capable of determining whether the user identifier is on a list of user identifiers to be throttled in response to the parameter being below the threshold.

12. The computer program product of claim 11, further comprising a sixth executable portion capable of sending a message to remove the user identifier from the list in response to the user identifier being on the list.

13. The computer program product of claim 11, further comprising a sixth executable portion capable of receiving an indication that a response is being sent to the client in response to the user identifier not being on the list.

14. The computer program product of claim 13, further comprising a seventh executable portion capable of decrementing the recorded number of active requests in response to receipt of the indication.

15. The computer program product of claim 9, wherein the parameter is at least one of a number of active requests and a number of active requests per a given unit of time.

16. A system for throttling data traffic on a network to a client, the system comprising:
an application node receiving requests from the client via the network; and
a throttle manager in communication with the application node, the throttle manager being configured to track a parameter that is based on a number of active requests associated with a user identifier associated with the client,
wherein the throttle manager is configured to determine whether to restrict responses to the requests responsive to a relationship of the parameter to a threshold.

17. The system of claim 16, wherein the throttle manager is configured to direct the application node to add the user identifier to a list of user identifiers to be throttled responsive to the parameter being above the threshold.

18. The system of claim 17, wherein the application node is configured to send an error message to the client in response to the user identifier being on the list.

19. The system of claim 16, wherein the throttle manager is configured to determine whether the user identifier is on a list of user identifiers to be throttled in response to the parameter being below the threshold.

20. The system of claim 19, wherein the throttle manager is configured to send a message to the application node directing the application node to remove the user identifier from the list in response to the user identifier being on the list.

21. The system of claim 19, wherein the application node is configured to send an indication to the throttle manager indicating that a response is being sent to the client in response to the user identifier not being on the list.

22. The system of claim 21, wherein the throttle manager is configured to decrement the recorded number of active requests in response to the indication from the application node.

23. The system of claim 16, wherein the parameter is at least one of a number of active requests and a number of active requests per a given unit of time.

24. A method of throttling data traffic to a client comprising:
receiving a client request associated with a user identifier;
relaying the client request to a throttle manager configured to track a parameter that is based on a number of active requests received from the user identifier;
adding the user identifier to a list of user identifiers to be throttled in response to a first message from the throttle manager;
removing the user identifier from the list in response to a second message from the throttle manager;
providing indication to the throttle manager that a response is sent to the client in response to the user identifier not being on the list; and
restricting data traffic to the client in response to the user identifier being on the list.

25. The method of claim 24, further comprising sending an error message to the client in response to the user identifier being on the list.

26. A computer program product for throttling data traffic to a client, the computer program product comprising at least one computer-readable storage medium having computer-readable program code portions stored therein, the computer-readable program code portions comprising:
a first executable portion capable of receiving a client request associated with a user identifier;
a second executable portion capable of relaying the client request to a throttle manager configured to track a parameter that is based on a number of active requests received from the user identifier;
a third executable portion capable of adding the user identifier to a list of user identifiers to be throttled in response to a first message from the throttle manager;
a fourth executable portion capable of removing the user identifier from the list in response to a second message from the throttle manager;
a fifth executable portion capable of providing indication to the throttle manager that a response is sent to the client in response to the user identifier not being on the list; and
a sixth executable portion capable of restricting data traffic to the client in response to the user identifier being on the list.

27. The computer program product of claim 26, further comprising a seventh executable portion capable of sending an error message to the client in response to the user identifier being on the list.

28. A method of throttling data traffic to a client comprising:
receiving notification of a client request associated with a application resource identifier;
incrementing a recorded number of active requests for the application resource identifier;
determining, responsive to the incremented number of active requests, whether a parameter based on the incremented recorded number of active requests is above a threshold; and
determining whether to restrict data traffic to the client responsive to a relationship of the parameter to the threshold.

29. The method of claim 28, further comprising sending a message to direct that the application resource identifier be added to a list of feature addresses to be throttled responsive to the parameter being above the threshold.

30. The method of claim 28, wherein the parameter is at least one of a number of active requests and a number of active requests per a given unit of time.

31. A computer program product for throttling data traffic to a client, the computer program product comprising at least one computer-readable storage medium having computer-readable program code portions stored therein, the computer-readable program code portions comprising:
a first executable portion capable of receiving notification of a client request from a application resource identifier;
a second executable portion capable of incrementing a recorded number of active requests for the application resource identifier;
a third executable portion capable of determining, responsive to the incremented number of active requests, whether a parameter based on the incremented recorded number of active requests is above a threshold; and
a fourth executable portion capable of determining whether to restrict data traffic to the client responsive to a relationship of the parameter to the threshold.

32. The computer program product of claim 31, further comprising a fifth executable portion capable of sending a message to direct the application resource identifier to be added to a list of application resource identifiers to be throttled responsive to the parameter being above the threshold.

33. The computer program product of claim 31, wherein the parameter is at least one of a number of active requests and a number of active requests per a given unit of time.
